(19) United States
(12) Patent Application Publication
(10) Pub. No.: US 2025/0246939 A1
(43) Pub. Date: Jul. 31, 2025

(54) CAVITY RESONANT POWER TRANSMISSION DEVICE AND WIRELESS POWER TRANSMISSION SYSTEM

(71) Applicant: Murata Manufacturing Co., Ltd., Kyoto-fu (JP)

(72) Inventor: Hiromasa SAEKI, Nagaokakyo-shi (JP)

(73) Assignee: Murata Manufacturing Co., Ltd., Kyoto-fu (JP)

(21) Appl. No.: 19/184,184

(22) Filed: Apr. 21, 2025

Related U.S. Application Data
(63) Continuation of application No. PCT/JP2024/027262, filed on Jul. 31, 2024.

(30) Foreign Application Priority Data
Dec. 15, 2023 (JP) 2023-212366

(51) Int. Cl. H02J 50/12; H02J 50/00; H02J 50/40; H02J 50/70

(52) U.S. Cl. CPC H02J 50/12; H02J 50/005; H02J 50/40; H02J 50/70

(57) ABSTRACT

A cavity resonant power transmission device includes a structure, a power transmitter, and a partition, in which the structure is entirely surrounded by an electromagnetic wave shielding member having conductivity. The power transmitter wirelessly supplies power to a product via a power receiver in an inner space of the structure, and the partition separates the power receiver from the power transmitter. The structure has a bottom portion, a top portion facing the bottom portion, and a side portion connecting outer edges of the bottom portion and the top portion. The power transmitter is in contact with an inner surface of the bottom portion.

### CROSS-REFERENCE TO RELATED APPLICATIONS

This application claims benefit of priority to International Patent Application No. PCT/JP2024/027262, filed Jul. 31, 2024, and to Japanese Patent Application No. 2023-212366, filed Dec. 15, 2023, the entire contents of each are incorporated herein by reference.

### BACKGROUND

### Technical Field

The present disclosure relates to a cavity resonant power transmission device and a wireless power transmission system, and in particular, to a cavity resonant power transmission device and a wireless power transmission system for efficiently transmitting wireless power.

### Background Art

Many electronic devices in recent years are products that contain a rechargeable battery so that they can be charged repeatedly. These products are manufactured by manufacturers, and then packed, shipped, and displayed in stores such as mass retailers or the like.

The rechargeable battery contained in the electronic device displayed in the mass retailers or the like gradually loses power due to dark current. If the rechargeable battery is in an over-discharge state, in which the rechargeable battery is discharged beyond a safe discharge range, the rechargeable battery may deteriorate or be damaged.

To avoid the over-discharge state, the electronic devices that have been shipped must be charged after a certain period of time has passed. However, the electronic devices displayed in mass retailers or the like are usually packed in some way, and therefore, in order to return the electronic devices to a charged state, it is necessary to unpack the electronic devices, charge the electronic devices, and pack the electronic devices again after charging.

It requires a high cost to unpack the electronic devices, and pack the electronic devices again after charging. However, if the electronic devices can be charged in a packed state, the cost can be reduced. The number of the electronic devices collected from the mass retailers or the like for charging varies depending on the volume of products distributed. Therefore, it is desirable to be able to charge, in some cases, a large number of products uniformly at once.

Japanese Unexamined Patent Application Publication (Translation of PCT Application) No. 2015-502726 discloses a method that including a step of using electrical energy from a solar cell module to energize at least one wireless energy supply source to thereby generate an oscillating magnetic field, and a step of constituting the supply source to exhibit an impedance with respect to the solar cell module. The energy is extracted from the solar cell module by the impedance. By using the wireless power supply of Japanese Unexamined Patent Application Publication (Translation of PCT Application) No. 2015-502726, the batteries can be charged without unpacking a plurality of products. However, in the method of Japanese Unexamined Patent Application Publication (Translation of PCT Application) No. 2015-502726, there is a problem that the charge amount that can be charged by power receivers decreases as the distance from a power transmitter increases.

On the other hand, Japanese Patent No. 7307933 discloses a method for efficiently supplying power even at a position away from the power transmitter by exciting and using a resonant mode in the whole space surrounded by a conductor.

### SUMMARY

However, in Japanese Patent No. 7307933, since the power transmitter is disposed at the top portion of a housing, it can only handle wireless power supply of a small amount of energy. In order to transmit power to a large number of products as in Japanese Unexamined Patent Application Publication (Translation of PCT Application) No. 2015-502726, it is inevitable to increase the size of the power transmitter, which will reduce the stability of the housing.

To solve such a problem, it is considered to dispose the power transmitter at the bottom portion of the housing. However, it has been found that, in a device in which the power transmitter is disposed at the bottom portion of the housing, it is difficult to sufficiently charge the power receivers disposed at the bottom portion of the housing when the power receivers are stacked. This is a problem newly found by the inventor of the present disclosure.

Accordingly, the present disclosure provides a device and a system capable of simultaneously transmitting power to a plurality of power receivers and supplying power uniformly without attenuation with respect to the distance from the power transmitter.

A cavity resonant power transmission device of the present disclosure includes a structure, a power transmitter, and a partition, in which the structure is entirely surrounded by an electromagnetic wave shielding member having conductivity. The power transmitter wirelessly supplies power to a product via a power receiver disposed in an inner space of the structure, and the partition separates the power receiver from the power transmitter. The structure has a bottom portion, a top portion facing the bottom portion, and a side portion connecting outer edges of the bottom portion and the top portion. The power transmitter is provided in contact with an inner surface of the bottom portion.

A wireless power transmission system of the present disclosure includes the cavity resonant power transmission device of the present disclosure, and a power receiver disposed in the inner space of the structure of the cavity resonant power transmission device. The power transmitter is configured to wirelessly supply power to a product via the power receiver.

According to the present disclosure, it is possible to provide a device and a system capable of simultaneously transmitting power to a plurality of power receivers and supplying power uniformly without attenuation with respect to the distance from the power transmitter.

### BRIEF DESCRIPTION OF THE DRAWINGS

FIG. 1 is a schematic perspective view showing an example of a wireless power transmission system according to a first embodiment of the present disclosure;

FIG. 2 is a schematic view showing an example of a power transmitter according to the present disclosure;

FIG. 3 is a schematic view showing an example of a power receiver according to the present disclosure;

FIG. 4 is a schematic view showing an example of the power receiver and a product according to the present disclosure;

FIG. 5 is a schematic view showing an example of the electric field intensity distribution of TE modes in an inner space of a cavity resonant power transmission device;

FIG. 6 is a schematic perspective view showing an example of a wireless power transmission system according to a second embodiment of the present disclosure;

FIG. 7 is a schematic perspective view showing an example of a wireless power transmission system according to a third embodiment of the present disclosure;

FIG. 8 is a schematic sectional view showing an example of a wireless power transmission system according to a fourth embodiment of the present disclosure;

FIG. 9 is a schematic sectional view showing another example of the wireless power transmission system according to the fourth embodiment of the present disclosure; and

FIG. 10 is a schematic sectional view showing another example of the wireless power transmission system of the present disclosure.

### DETAILED DESCRIPTION

A cavity resonant power transmission device and a wireless power transmission system of the present disclosure will be described below.

However, the present disclosure is not limited to the following embodiments, and may be changed and applied as appropriate without changing the gist of the present disclosure. It should be noted that a combination of two or more of the individual preferable configurations of the present disclosure described below is also included in the present disclosure.

Each embodiment described below is an example; and it is needless to say that partial replacement or combination of the configurations shown in the different embodiments is possible. In the second embodiment and subsequent embodiments, the description of matters common to the first embodiment will be omitted, and only different points will be described. In particular, similar effects by similar configurations will not be referred to one by one in each embodiment.

In the following description, if the respective embodiments are not specifically distinguished, they are simply referred to as “the cavity resonant power transmission device of the present disclosure” and “the wireless power transmission system of the present disclosure.

The drawings referred to below are schematic views, and their dimensions, scale of aspect ratio and the like may differ from the actual product. In the drawings, the same or equivalent parts are denoted by the same symbol. In each drawing, the same elements are denoted by the same symbol, and the descriptions thereof are omitted.

In the present specification, terms indicating relationships between elements (for example, “perpendicular to”, “parallel to”, and “orthogonal to”) and terms indicating the shape of an element are not expressions that indicate only a strict meaning, but expressions that also include a range of substantial equivalence, with a difference of a few percent, for example. Also, in the present specification, the word “constant” is not an expression that indicates only completely constant, but an expression that also includes a case of substantial constant, with a difference of a few percent, for example.

In the present specification, a width direction, a length direction, and a height direction are defined by X, Y, and Z, respectively, as shown in FIG. 1 and the like. The width direction X, the length direction Y, and the height direction Z are orthogonal to each other. A direction orthogonal to the height direction Z and containing the width direction X and the length direction Y is defined as a plane direction (XY plane direction). In the present specification, it is preferable that the height direction Z is a vertical direction. In such a case, the XY plane is a horizontal plane.

A first embodiment of the wireless power transmission system according to the present disclosure will be described below with reference to FIG. 1.

FIG. 1 is a schematic perspective view showing an example of the wireless power transmission system according to the first embodiment of the present disclosure. In FIG. 1, a wireless power transmission system 500 includes a cavity resonant power transmission device 100, and power receivers 30 disposed in the inner space of a structure 10 of the cavity resonant power transmission device 100. A power transmitter 20 wirelessly supplies power to products 31 via the power receivers 30.

The cavity resonant power transmission device 100 includes the structure 10, the power transmitter 20, and a partition 40, in which the structure 10 is entirely surrounded by an electromagnetic wave shielding member having conductivity, the power transmitter 20 wirelessly supplies power to the products 31 via the power receivers 30 disposed in the inner space of the structure 10, and the partition 40 separates the power receivers 30 from the power transmitter 20.

The structure 10 has a rectangular parallelepiped shape, for example, and includes a bottom portion 11, a top portion 12 facing the bottom portion 11, and a side portion 13 connecting the outer edges of the bottom portion 11 and the top portion 12. The bottom portion 11 and the top portion 12 face each other in the Z direction, with the bottom portion 11 positioned on the lower side of the Z direction and the top portion 12 positioned on the upper side of the Z direction. The bottom portion 11 and the top portion 12 are surfaces parallel to the XY plane, for example, as shown in FIG. 1. It is preferable that the structure 10 is shaped to have a longitudinal direction in the Z direction from the bottom portion 11 to the top portion 12, as shown in FIG. 1. The shape of the structure 10 is not limited to a rectangular parallelepiped shape, but may alternatively be, for example, a pentagonal prism shape in which the XY plane is a pentagon, a quadrangular prism shape in which the XY plane is a trapezoid, or a semicircular prism shape in which the XY plane is a semicircle; however, in any of the shapes, it is preferable that the structure 10 is shaped to have a longitudinal direction in the Z direction from the bottom portion 11 to the top portion 12.

The cavity resonant power transmission device 100 uses a resonant mode in the structure 10. Since the structure 10 has an inner space shielded by an electromagnetic wave shielding member, it can be considered as a resonator. When the length of the resonator in the width direction is a (X direction), the length of the resonator in the length direction is b (Y direction), and the length of the resonator in the vertical direction is c (Z direction), the resonant frequency fᵣ can be determined by Equation 1.

fᵣ=v/(2π×(μᵣμεᵣ)^{1/2})×{(mπ/a)²+(nπ/b)²+(pπ/c)²}^{1/2} [Equation 1]

Here, v represents the speed of light, μᵣ represents the relative permeability, εᵣ represents the relative permittivity, and m, n, and p represent integers.

In the cavity resonant power transmission device 100, m is an index of the resonator (the structure 10) in the width direction (X direction), n is an index of the resonator (the structure 10) in the length direction (Y direction), and p is an index of the resonator (the structure 10) in the vertical direction (Z direction).

The material of the electromagnetic wave shielding member is not particularly limited as long as it has conductivity; however, it is preferable that the electromagnetic wave shielding member is made of a metal material such as copper, aluminum, iron, or stainless steel, nickel. Alternatively, the electromagnetic wave shielding member may also be made of a conductive oxide material, graphite, an organic conductive material or the like, in which examples of the conductive oxide material include zinc oxide, titanium oxide, and indium tin oxide (ITO). Further, the electromagnetic wave shielding member may alternatively be made of an alloy or a mixture as long as such alloy or mixture has conductivity. The electromagnetic wave shielding member may have a multilayer structure made of these materials.

The shape of the electromagnetic wave shielding member may alternatively be plate-like, mesh-like, membrane-like, porous or the like, as long as the electromagnetic wave shielding member blocks electromagnetic waves at the frequency of the power supply. Further, the electromagnetic wave shielding member may be coated with an electromagnetic wave transmitting material for the purpose of surface protection and the like. Note that it is sufficient if the electromagnetic wave shielding member can block electromagnetic waves only at the frequency used for wireless power transmission. In other words, the electromagnetic wave shielding member does not have to block communications at a frequency different from the frequency used for wireless power transmission.

For example, the power transmitter 20 is provided only in contact, at the center of the bottom portion 11 of the structure 10, with the inner surface of the bottom portion 11, as shown in FIG. 1. The power transmitter 20 may be in contact with the inner surface of the side portion 13, as long as the power transmitter 20 is in contact with the inner surface of the bottom portion 11. The position of the power transmitter 20 may alternatively be offset from the center of the bottom portion 11 of the structure 10.

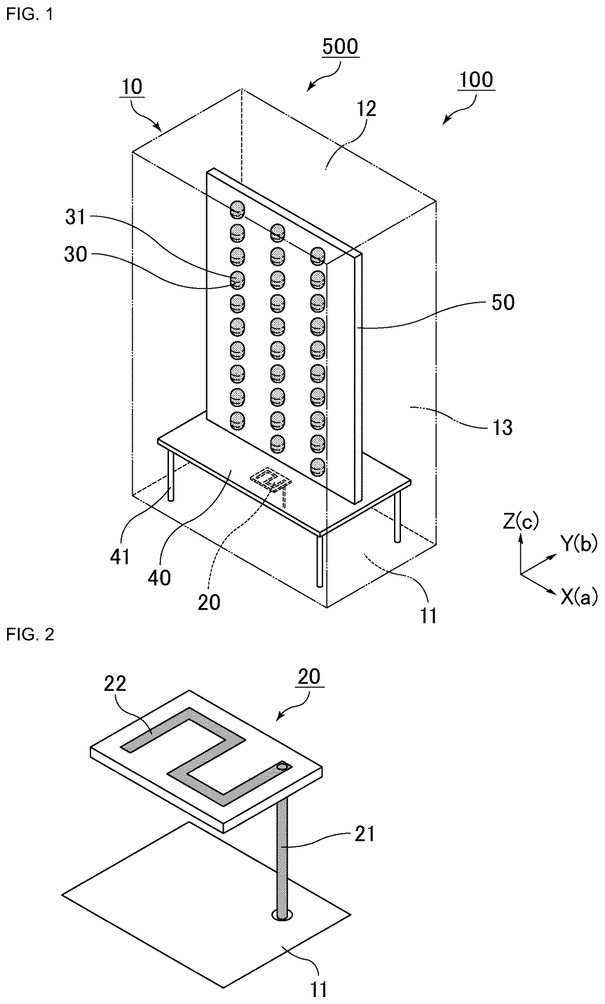

The configuration of the power transmitter 20 will be described with reference to FIG. 2. FIG. 2 is a schematic view showing an example of the power transmitter according to the present disclosure. The power transmitter 20 is composed of, for example, a metal rod 21, and a power transmission antenna wiring 22 disposed in a direction perpendicular to the metal rod 21. It is preferable that the metal rod 21 is disposed substantially perpendicular to the electromagnetic wave shielding member. At this time, the metal rod 21 is disposed so that it does not electrically contact the electromagnetic wave shielding member, but is electrically connected to a matching circuit and a high-frequency power supply (not shown) provided outside the resonator (the structure 10) through the electromagnetic wave shielding member.

The matching circuit is connected between the power transmitter 20 and the high-frequency power supply. The matching circuit is adjusted so as to achieve impedance matching with the resonator at a preset power transmission frequency.

Note that, if the reference potential of the matching circuit and the high-frequency power supply is substantially the same as the reference potential of the electromagnetic wave shielding member, the matching circuit may be connected appropriately via a connector such as a sub miniature type A (SMA) terminal. If the reference potential of the matching circuit and the high-frequency power supply is different from the reference potential of the electromagnetic wave shielding member, the same effect can be obtained by using a dipole antenna 37 or a loop antenna (not shown) as in the case of the power receiver 30 described later. The power transmission antenna wiring 22 may be wired on a printed circuit board; alternatively, the metal rod 21 may be bent to serve as the power transmission antenna wiring 22. The power transmission antenna wiring 22 may be appropriately bent within the wiring plane. It is preferable that the power transmission antenna wiring 22 is formed substantially parallel to the wall surface of the resonator (the structure 10) composed of the electromagnetic wave shielding member when the electric field is used for power transmission, and is formed substantially perpendicular to the wall surface of the resonator (the structure 10) composed of the electromagnetic wave shielding member when the magnetic field is used for power transmission.

For example, the main surface of the partition 40 is a flat plate in the shape of a rectangle, as shown in FIG. 1. It is preferable that the partition 40 is provided so that the main surface is parallel to the bottom portion 11 of the structure 10. In FIG. 1, one end of four legs 41 is bonded to the four corners of the rectangle of the partition 40, and the other end of the legs 41 is in contact with the bottom portion 11 of the structure 10. The other end of the legs 41 may be fixed to the bottom portion 11 of the structure 10.

The shape of the main surface of the partition 40 may be the same as the bottom portion 11 of the structure 10; in such a case, the edge portion of the main surface of the partition 40 may be bonded to the inner side of the side portion 13 of the structure 10. The partition 40 may also be a flat plate of a shape other than a rectangle.

It is preferable that the partition 40 is made of a material that has insulating properties in the resonant frequency band used in the present disclosure. Examples of such materials include synthetic resin-based materials, paper, and wood; examples of more desirable materials include fluororesin and polystyrene resin having low relative permittivity. If the mechanical strength permits, the partition 40 does not have to be in the form of bulk like styrene foam.

If the power receiver 30 is too close to the power transmitter 20, the impedance change will become remarkable, and the resonant frequency will shift, so that the charging will not be sufficiently performed. In FIG. 1, in order to separate the power receiver 30 from the power transmitter 20, the partition 40 is separated from the power transmitter 20. It is preferable that the separation distance between the partition 40 and the power transmitter 20 is equal to or greater than ⅓ of the wavelength of the resonant frequency used for wireless power supply. On the other hand, the upper limit for the separation distance between the partition 40 and the power transmitter 20 is defined by a position of the antenna of the power receiver 30 described later where the antenna can be separated from the top portion 12 by at least ⅓ of the wavelength of the resonant frequency used for wireless power supply. The resonant frequency used for wireless power supply is 2.00 GHz or higher and 3.00 GHz or lower (i.e., from 2.00 GHz to 3.00 GHz), for example. When the resonant frequency is in the above range, the wavelength is 99.93 mm or more and 149.90 mm or less (i.e., from 99.93 mm to 149.90 mm).

In order to provide a larger space for disposing the power receivers 30, it is preferable that the partition 40 is disposed closer to the bottom portion 11 than to the top portion 12.

The partition 40 may be in contact with the power transmitter 20. In such a case, in order to separate the power receiver 30 from the power transmitter 20, it is preferable that the partition 40 has a thickness equal to or greater than ⅓ of the wavelength of the resonant frequency used for wireless power supply in the Z direction. The partition 40 may have a space inside.

In the cavity resonant power transmission device 100, it is preferable that a guide 50 for restricting the position and direction of the power receiver 30 is provided in a region of the inner space where the power receiver 30 is disposed. The guide 50 is, for example, a rectangular plate-like member, and has recesses for fitting the power receivers 30 uniformly provided in its main surface. When a plurality of power receivers 30 are provided in the inner space, it is preferable to provide the guide 50 so that power is uniformly supplied to all of the plurality of power receivers 30. When the mode has characteristics in the power supply direction, such as TE110, it is preferable to restrict the direction of the power receiver 30.

In FIG. 1, the guide 50 is fixed perpendicular to the upper main surface of the partition 40. Alternatively, instead of being fixed to the partition 40, the guide 50 may be, for example, fitted to a frame (not shown) provided on the upper main surface of the partition 40, so that it can be taken in and out of the cavity resonant power transmission device 100. By fitting the guide 50 to the frame, the position of the guide 50 in the cavity resonant power transmission device 100 can be fixed. If the guide 50 is a plate-like member, the number of the guide 50 provided in the inner space may be to one, two or more. When two or more guides 50 are provided, for example, the guides 50 may be arranged side by side in the Y direction, but are not particularly limited to such an arrangement. The shape of the guide 50 is not limited to a plate-like shape as long as the guide 50 restricts the position and direction of the power receiver 30.

In the wireless power transmission system 500 shown in FIG. 1, the power receivers 30 are arranged in the cavity resonant power transmission device 100 in a matrix with three in the X direction and 10 in the Z direction. The number and direction of the arranged power receivers 30 are not particularly limited; however, from the viewpoint of efficiency, it is preferable that a plurality of power receivers 30 are provided, it is preferable that a plurality of power receivers 30 are arranged in the Z direction, and it is preferable that all of the power receivers 30 are oriented in the same direction.

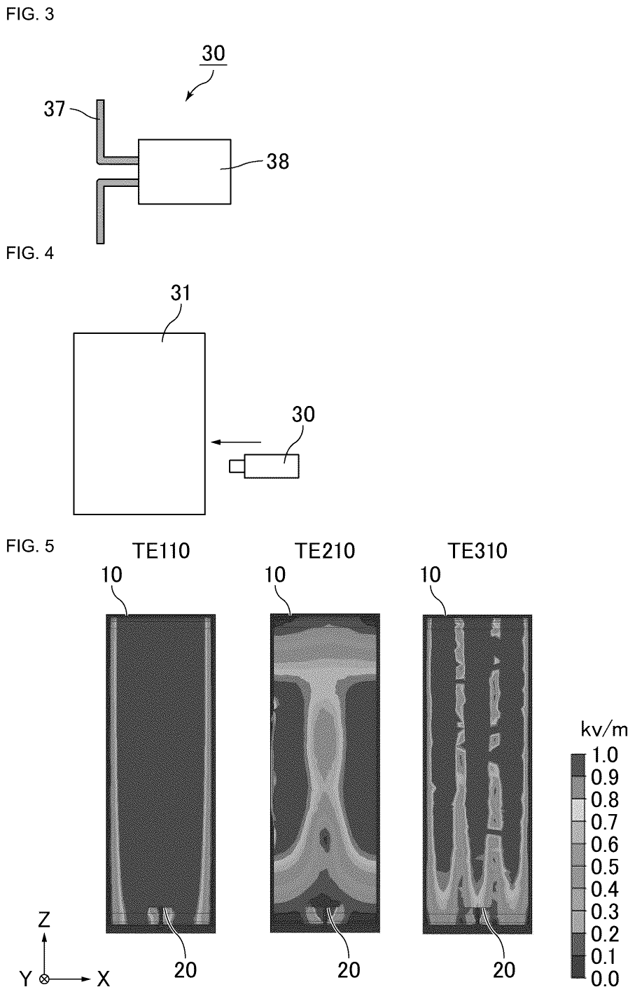

The configuration of the power receiver 30 will be described with reference to FIG. 3. FIG. 3 is a schematic view showing an example of the power receiver according to the present disclosure. The power receiver 30 is composed of, for example, the electrical wiring portion 37, which serves as an antenna, and a rectifier circuit 38. A switch, a matching circuit, and/or the like may be added as necessary. The antenna is typically the dipole antenna 37, a loop antenna (not shown) or the like. The dipole antenna 37 may be bent appropriately. Alternatively, an inverted F-type structure may be used, in which part of the wiring is short-circuited to the ground or to a part that serves as the reference potential of the power receiver 30. It is also possible to adjust the corresponding frequency by inserting a capacitor or an inductor into a part of the antenna wiring. These components may be selected according to the resonant frequency derived from the resonator formed by the electromagnetic wave shielding member.

In the present embodiment, as shown in FIG. 1, the product 31 having the power receiver 30 inside is disposed in the inner space of the structure 10. Examples of the product 31 include IoT devices and electronic devices; examples of the IoT devices include wireless earphones, smart watches, electronic pens, rechargeable toys, power tools, drive recorders, laptop computers, remote controls, drones, and examples of the electronic devices include smart meters, wireless speakers, batteries, and sensor modules.

The power receiver 30 may be separable from the product 31 as shown in FIG. 4. FIG. 4 is a schematic view showing an example of the power receiver and the product according to the present disclosure. The wireless power transmission system 500 may be a system in which power is wirelessly supplied in a state where the power receiver 30 is connected to a charging terminal of the product 31, and the product 31 and the power receiver 30 are disposed in the inner space of the structure 10.

In the cavity resonant power transmission device 100, it is preferable to transmit power while switching between odd and even numbers of at least one of indexes m and n of the resonant frequency in the inner space. In the present specification, 0 is not included in even numbers. The indexes m and n are preferably odd or even numbers of 1 or more and 10 or less (i.e., from 1 to 10), and more preferably odd or even numbers of 1 or more and 5 or less (i.e., from 1 to 5). Specific examples include TE110, TE210, and TE120.

The values of the indexes and the electric field intensity distribution will be described with reference to FIG. 5. FIG. 5 is a schematic view showing an example of the electric field intensity distribution of the TE modes in the inner space of the cavity resonant power transmission device.

As shown in FIG. 5, in the TE110 mode where the indexes m and n are 1 and p is 0, the electric field in the central portion of the inner space in the X direction becomes strong. In the TE210 mode where the index m is 2, the index n is 1, and the index p is 0, the electric field in the central portion of the inner space in the X direction becomes weak, and the electric field around such a portion becomes strong. In the TE310 mode where the index m is 3, n is 1, and p is 0, an area of strong electric field, an area of weak electric field, and an area of strong electric field appear from the central portion in the X direction toward both end portions. By transmitting power while switching between odd and even numbers of at least one of the indexes m and n, even if a plurality of power receivers are disposed in a wide range in the X direction and the Y direction, it is possible to transmit power uniformly and efficiently to all of the plurality of power receivers 30.

In the cavity resonant power transmission device 100, it is preferable that the resonant frequency in the inner space is in the TE110 mode. This is because, when a plurality of power receivers are disposed in the Z direction from the bottom portion to the top portion direction, it is possible to efficiently supply power to all of the plurality of power receivers.

In the cavity resonant power transmission device 100, when the resonant frequency is in an (m, n, p) mode, it is preferable to transmit power while performing switching such that any one of m, n, and p becomes 0. When any one of m, n, and p is 0, the electric field in the direction of 0 becomes constant, and therefore even when a plurality of power receivers 30 are randomly disposed, power can be uniformly transmitted to all of the plurality of power receivers 30 by transmitting power while performing switching.

In the cavity resonant power transmission device 100, it is preferable to switch the resonant frequency at an interval of 0.3 seconds or more. When the resonant frequency is switched at an interval of 0.3 seconds or more, sufficient power can be secured and a DC-to-DC converter for operating the power transmitter can operate normally. On the other hand, it is preferable to switch the resonant frequency at an interval of 1 second or less.

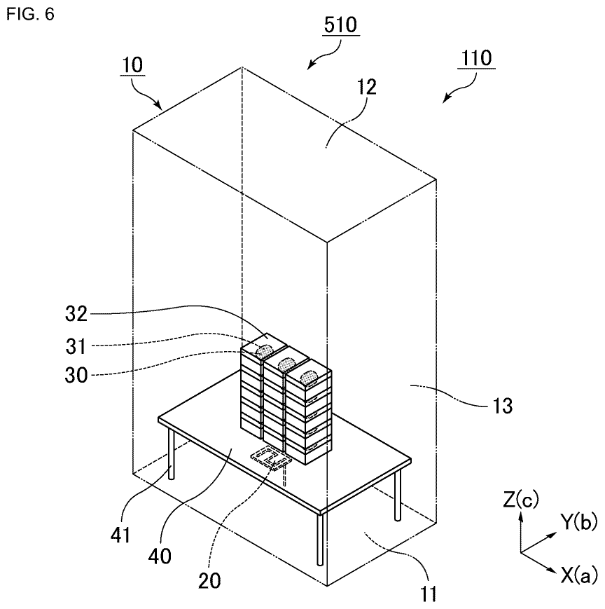

A wireless power transmission system 510, as a second embodiment of the wireless power transmission system of the present disclosure, will be described below with reference to FIG. 6. Here, only the parts of the wireless power transmission system 510 that differ from the wireless power transmission system 500 will be described.

FIG. 6 is a schematic perspective view showing an example of the wireless power transmission system according to the second embodiment of the present disclosure. The wireless power transmission system 510 includes a cavity resonant power transmission device 110. The cavity resonant power transmission device 110 does not include a guide 50.

In the wireless power transmission system 510 shown in FIG. 6, products 31 having power receivers 30 inside are packed in boxes 32, and the boxes 32 are mounted directly on a main surface of a partition 40. The boxes 32 are stacked in five stages in the Z direction, and each stage has three boxes 32 arranged in the X direction. The number and arrangement of the boxes 32 to be mounted on the partition 40 are not particularly limited, but it is preferable that a plurality of boxes 32 are stacked in the Z direction.

In order to uniformly transmit power to the plurality of power receivers 30, it is preferable that the directions of the power receivers 30 are unified; however, the directions of the power receivers 30 do not have to be unified. The products 31 having the power receivers 30 inside do not have to be packed in the boxes 32.

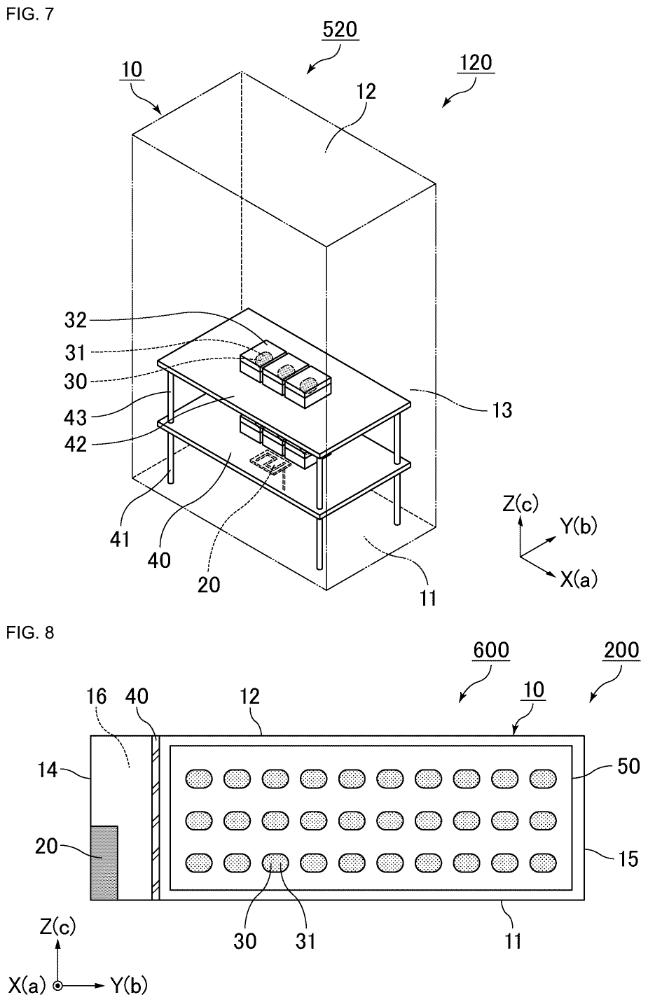

A wireless power transmission system 520, as a third embodiment of the wireless power transmission system of the present disclosure, will be described below with reference to FIG. 7. Hereinafter, only the parts of the wireless power transmission system 520 that differ from the wireless power transmission system 510 will be described.

FIG. 7 is a schematic perspective view showing an example of the wireless power transmission system according to the third embodiment of the present disclosure. The wireless power transmission system 520 includes a cavity resonant power transmission device 120.

The cavity resonant power transmission device 120 includes a shelf 42 for further disposing power receivers 30 between a partition 40 and a top portion 12. The shelf 42 is, for example, is a flat plate in the shape of a rectangle, as shown in FIG. 7, and the area of the main surface of the shelf 42 is the same as that of the partition 40. It is preferable that the shelf 42 is provided so that its main surface is parallel to the main surface of the partition 40. In FIG. 7, one end of four legs 43 is bonded to the four corners of the rectangle of the shelf 42, and the other end of the legs 43 is in contact with the main surface of the partition 40 on the top portion 12 side. The other end of the legs 43 may be fixed to the partition 40.

The shape of the main surface of the shelf 42 may be the same as the bottom portion 11 of the structure 10; in such a case, the edge portion of the main surface of the shelf 42 may be bonded to the inner side of the side portion 13 of the structure 10. The shelf 42 may be a flat plate of a shape other than a rectangle. Two or more shelves 42 may be provided in the Z direction at intervals.

In the cavity resonant power transmission device 120, three products 31 having power receivers 30 inside are disposed, in a state of being packed in boxes 32, in the X direction on the main surface of the partition 40, and in the X direction on the main surface of the shelf 42. The number and arrangement of the boxes 32 mounted on the partition 40 and on the shelf 42 are not particularly limited. For example, a plurality of boxes 32 may be stacked in the Z direction on each of the partition 40 and the shelf 42. Also, it is not necessary for the box 32 to be mounted on the partition 40.

In contrast to the wireless power transmission system 520 shown in FIG. 7, in the wireless power transmission system 500 shown in FIG. 1, the power receivers 30 and the products 31 are in an unpacked state, and the power transmitter 20 is configured to wirelessly supply power to the products 31 via the power receivers 30 in the unpacked state.

A wireless power transmission system 600, as a fourth embodiment of the wireless power transmission system of the present disclosure, will be described below with reference to FIG. 8. Here, only the parts of the wireless power transmission system 600 that differ from the wireless power transmission system 500 will be described.

FIG. 8 is a schematic sectional view showing an example of the wireless power transmission system according to the fourth embodiment of the present disclosure. The wireless power transmission system 600 includes a cavity resonant power transmission device 200.

A structure 10 has a rectangular parallelepiped shape, for example, and includes a bottom portion 11, a top portion 12 facing the bottom portion 11, a first side portion 14 connecting the outer edges of the bottom portion 11 and a top portion 12, and a second side portion 15 facing the first side portion 14. The structure 10 further includes a third side portion 16 adjacent to the first side portion 14 or the second side portion 15, and a fourth side portion (not shown) facing the third side portion 16. It is preferable that the structure 10 is shaped to have a longitudinal direction from the first side portion 14 to the second side portion 15, as shown in FIG. 8. The shape of the structure 10 according to the present embodiment is not limited to a rectangular parallelepiped shape, but may alternatively be, for example, a pentagonal prism shape in which the XY plane is a pentagon, a quadrangular prism shape in which the XY plane is a trapezoid, or a semicircular prism shape in which the XY plane is a semicircle; however, in any of the shapes, it is preferable that the structure 10 is shaped to have a longitudinal direction in the Y direction from the first side portion 14 to the second side portion 15.

In the cavity resonant power transmission device 200, a power transmitter 20 is provided in contact with the inner surface of the bottom portion 11 and the inner surface of the first side portion 14. In the cavity resonant power transmission device 200, when the length of the resonator (the structure 10) in the width direction is a (X direction), b (Y direction), and the length of the resonator (the structure 10) in the vertical direction is c (Z direction), the resonant frequency fᵣ can be determined by Equation 2.

fᵣ=v/(2π×(μᵣμεᵣ)^{1/2})×{(mπ/a)²+(pπ/b)²+(nπ/c)²}^{1/2} [Equation 2]

Here, v represents the speed of light, μᵣ represents the relative permeability, εᵣ represents the relative permittivity, and m, n, and p represent integers.

In the cavity resonant power transmission device 200, m is an index of the resonator (the structure 10) in the width direction (X direction), n is an index of the resonator (the structure 10) in the vertical direction (Z direction), and p is an index of the resonator (the structure 10) in the length direction (Y direction).

In the cavity resonant power transmission device 200, it is preferable that a partition 40 is a flat plate having the same height as the first side portion 14 of the structure 10, and is provided so as to be parallel to the first side portion 14. In FIG. 8, the edge portion of the partition 40 is in contact with the bottom portion 11 and the top portion 12 of the structure 10.

In order to provide a larger space for disposing the power receivers 30, it is preferable that the partition 40 is disposed closer to the first side portion 14 than to the second side portion 15.

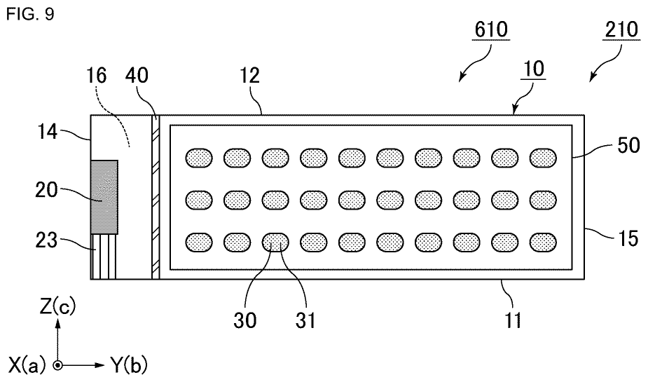

Next, a wireless power transmission system 610, as a modification of the fourth embodiment, will be described with reference to FIG. 9. Here, only the parts of the wireless power transmission system 610 that differ from the wireless power transmission system 600 will be described.

FIG. 9 is a schematic sectional view showing another example of the wireless power transmission system according to the fourth embodiment of the present disclosure. The wireless power transmission system 610 includes a cavity resonant power transmission device 210.

In the cavity resonant power transmission device 210, a power transmitter 20 is disposed at a central portion of the inner surface of the first side portion 14, in direct contact with the inner surface of the first side portion 14, and in indirect contact with the inner surface of the bottom portion 11. A scaffold 23 for applying the load of the power transmitter 20 to the bottom portion 11 is provided below the power transmitter 20.

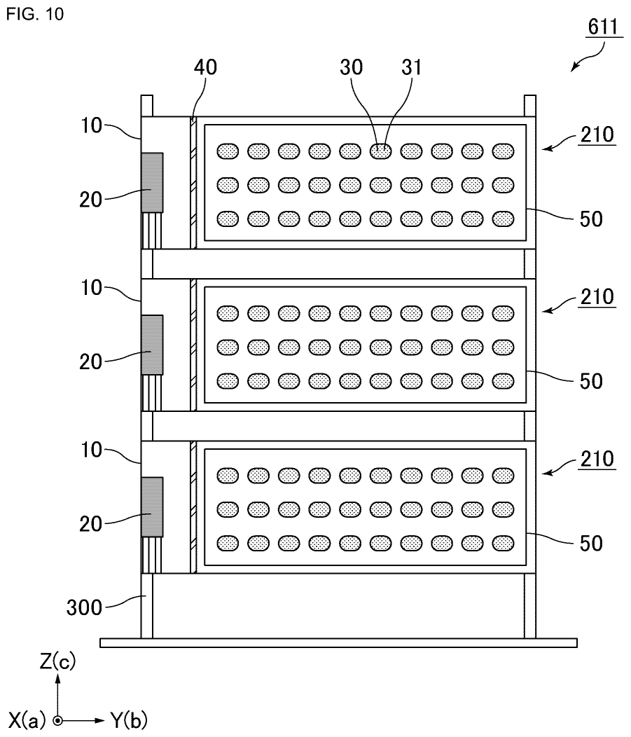

The wireless power transmission system of the present disclosure may include two or more cavity resonant power transmission devices. FIG. 10 is a schematic sectional view showing another example of the wireless power transmission system of the present disclosure. A wireless power transmission system 611 includes three cavity resonant power transmission devices 210. As shown in FIG. 10, in the wireless power transmission system 611, the plurality of cavity resonant power transmission devices 210 can be provided in the height direction by mounting the plurality of cavity resonant power transmission devices 210 on a frame 300.

When the wireless power transmission system of the present disclosure includes two or more cavity resonant power transmission devices, it is preferable that at least one cavity resonant power transmission device is the cavity resonant power transmission device of the present disclosure, and it is more preferable that all of the cavity resonant power transmission devices are the cavity resonant power transmission devices of the present disclosure. When two or more cavity resonant power transmission devices are the cavity resonant power transmission devices of the present disclosure, all of them may be cavity resonant power transmission devices of the same embodiment, or some or all of them may be cavity resonant power transmission devices of different embodiments.

The cavity resonant power transmission device provided in the wireless power transmission system of the present disclosure is also one of the present disclosures.

The following contents are disclosed in the present specification.
<1> A cavity resonant power transmission device comprising a structure, a power transmitter, and a partition, wherein the structure is entirely surrounded by an electromagnetic wave shielding member having conductivity. The power transmitter wirelessly supplies power to a product via a power receiver disposed in an inner space of the structure, and the partition separates the power receiver from the power transmitter. The structure has a bottom portion, a top portion facing the bottom portion, and a side portion connecting outer edges of the bottom portion and the top portion, and the power transmitter is provided in contact with an inner surface of the bottom portion.
<2> The cavity resonant power transmission device according to <1>, wherein the partition is separated from the power transmitter.
<3> The cavity resonant power transmission device according to <1> or <2>, wherein a separation distance between the partition and the power transmitter is equal to or greater than ⅓ of a wavelength of a resonant frequency used for wireless power supply.
<4> The cavity resonant power transmission device according to any one of <1> to <3>, wherein a guide that restricts a position and direction of the power receiver is provided in a region of the inner space where the power receiver is disposed.
<5> The cavity resonant power transmission device according to any one of <1> to <4>, wherein power is transmitted while switching between odd and even numbers of at least one of indexes m and n of a resonant frequency in the inner space.
<6> The cavity resonant power transmission device according to any one of <1> to <5>, wherein when a resonant frequency is in an (m, n, p) mode, power is transmitted while performing switching such that any one of m, n, and p becomes 0.
<7> The cavity resonant power transmission device according to <5> or <6>, wherein the resonant frequency is switched at an interval of 0.3 seconds or more.
<8> The cavity resonant power transmission device according to any one of <1> to <7>, wherein the power transmitter is provided only in contact with the inner surface of the bottom portion of the structure.
<9> The cavity resonant power transmission device according to any one of <1> to <8>, wherein the structure is shaped to have a longitudinal direction from the bottom portion to the top portion.
<10> The cavity resonant power transmission device according to <9>, wherein the partition is disposed closer to the bottom portion than to the top portion.
<11> The cavity resonant power transmission device according to <9> or <10>, wherein a shelf for further disposing the power receiver is provided between the partition and the top portion.
<12> The cavity resonant power transmission device according to any one of <1> to <11>, wherein a resonant frequency in the inner space is a TE110 mode.
<13> The cavity resonant power transmission device according to any one of <1> to <7>, wherein the side portion of the structure has a first side portion and a second side portion facing the first side portion, and the power transmitter is provided in contact with the inner surface of the bottom portion and an inner surface of the first side portion.
<14> The cavity resonant power transmission device according to <13>, wherein the structure is shaped to have a longitudinal direction from the first side portion to the second side portion.
<15> The cavity resonant power transmission device according to <13> or <14>, wherein the partition is disposed closer to the first side portion than to the second side portion.
<16> The cavity resonant power transmission device according to any one of <13> to <15>, wherein the power transmitter is provided in indirect contact with the inner surface of the bottom portion and in direct contact with the inner surface of the first side portion.
<17> A wireless power transmission system comprising the cavity resonant power transmission device according to any one of <1> to <16>; and a power receiver disposed in the inner space of the structure of the cavity resonant power transmission device. The power transmitter is configured to wirelessly supply power to a product via the power receiver.
<18> The wireless power transmission system according to <17>, wherein the power receiver includes a plurality of power receivers.
<19> The wireless power transmission system according to <17> or <18>, wherein the power receiver is separable from the product, the power receiver is connected to a charging terminal of the product, and power is wirelessly supplied in a state where the product is disposed in the inner space of the structure.
<20> The wireless power transmission system according to any one of <17> to <19>, wherein the power receiver is in an unpacked state, the power transmitter wirelessly supplies power to the product via the power receiver in the unpacked state.
<21> The wireless power transmission system according to any one of <17> to <19>, wherein the power receiver and the product are in a packed state, and the power transmitter wirelessly supplies power to the product via the power receiver in the packed state.
<22> The wireless power transmission system according to <21>, wherein the power receiver and the product are stacked on the partition in the packed state.

What is claimed is:

1. A cavity resonant power transmission device comprising:
a structure;
a power transmitter; and
a partition,
wherein
the structure is entirely surrounded by an electromagnetic wave shielding member having conductivity, the power transmitter is configured to wirelessly supply power to a product via a power receiver in an inner space of the structure, and the partition separates the power receiver from the power transmitter,
the structure has a bottom portion, a top portion facing the bottom portion, and a side portion connecting outer edges of the bottom portion and the top portion, and
the power transmitter is in contact with an inner surface of the bottom portion.

2. The cavity resonant power transmission device according to claim 1, wherein
the partition is separated from the power transmitter.

3. The cavity resonant power transmission device according to claim 1, wherein
a separation distance between the partition and the power transmitter is equal to or greater than ⅓ of a wavelength of a resonant frequency used for wireless power supply.

4. The cavity resonant power transmission device according to claim 1, further comprising:
a guide that is configured to restrict a position and direction of the power receiver in a region of the inner space that includes the power receiver.

5. The cavity resonant power transmission device according to claim 1, wherein
power is transmitted while switching between odd and even numbers of at least one of indexes m and n of a resonant frequency in the inner space.

6. The cavity resonant power transmission device according to claim 1, wherein
when a resonant frequency is in an (m, n, p) mode, power is transmitted while performing switching such that any one of m, n, and p becomes 0.

7. The cavity resonant power transmission device according to claim 5, wherein
the resonant frequency is switched at an interval of 0.3 seconds or more.

8. The cavity resonant power transmission device according to claim 1, wherein
the power transmitter is only in contact with the inner surface of the bottom portion of the structure.

9. The cavity resonant power transmission device according to claim 1, wherein
the structure has a longitudinal direction from the bottom portion to the top portion.

10. The cavity resonant power transmission device according to claim 9, wherein
the partition is closer to the bottom portion than to the top portion.

11. The cavity resonant power transmission device according to claim 9, further comprising:
a shelf for the power receiver between the partition and the top portion.

12. The cavity resonant power transmission device according to claim 1, wherein
a resonant frequency in the inner space is a TE110 mode.

13. The cavity resonant power transmission device according to claim 1, wherein
the side portion of the structure has a first side portion and a second side portion facing the first side portion, and
the power transmitter is in contact with the inner surface of the bottom portion and an inner surface of the first side portion.

14. The cavity resonant power transmission device according to claim 13, wherein
the structure has a longitudinal direction from the first side portion to the second side portion.

15. The cavity resonant power transmission device according to claim 13, wherein
the partition is closer to the first side portion than to the second side portion.

16. The cavity resonant power transmission device according to claim 13, wherein
the power transmitter is in indirect contact with the inner surface of the bottom portion and in direct contact with the inner surface of the first side portion.

17. A wireless power transmission system comprising:
the cavity resonant power transmission device according to claim 1; and
at least one power receiver in the inner space of the structure of the cavity resonant power transmission device,
wherein
the power transmitter is configured to wirelessly supply power to a product via the power receiver.

18. The wireless power transmission system according to claim 17, wherein
the at least one power receiver includes a plurality of power receivers.

19. The wireless power transmission system according to claim 17, wherein
the power receiver is separable from the product,
the power receiver is connected to a charging terminal of the product, and
power is wirelessly supplied in a state where the product is in the inner space of the structure.

20. The wireless power transmission system according to claim 17, wherein
the power receiver is in an unpacked state,
the power transmitter is configured to wirelessly supply power to the product via the power receiver in the unpacked state.

21. The wireless power transmission system according to claim 17, wherein
the power receiver and the product are in a packed state, and
the power transmitter is configured to wirelessly supply power to the product via the power receiver in the packed state.

22. The wireless power transmission system according to claim 21, wherein
the power receiver and the product are stacked on the partition in the packed state.
